(19) United States
(12) Patent Application Publication
(10) Pub. No.: US 2014/0289428 A1
(43) Pub. Date: Sep. 25, 2014

(54) Dynamic Intervals for Synchronizing Data

(71) Applicant: MICROSOFT CORPORATION, Redmond, WA (US)

(72) Inventors: Jason D. Walter, San Jose, CA (US); Ashutosh Tewari, Fremont, CA (US); Krishna Vitaldevara, Fremont, CA (US)

(21) Appl. No.: 13/848,021

(22) Filed: Mar. 20, 2013

(51) Int. Cl. H04L 12/24

(52) U.S. Cl. CPC H04L 41/50
USPC 709/248

(57) ABSTRACT

In embodiments of dynamic intervals for synchronizing data, the data is periodically synchronized between computing devices, such as between server devices, client devices, and/or between client and server devices. A polling optimization service can assess heuristics that are associated with the data synchronizations between the computing devices, and determine optimal dynamic intervals to periodically synchronize the data based on the heuristics. The polling optimization service can then iterate to further assess the heuristics that are associated with subsequent data synchronizations and determine updates of the optimal dynamic intervals. The polling optimization service updates the heuristics based on the subsequent and ongoing data synchronizations, and iterates to update the optimal dynamic intervals based on the updated heuristics.

### BACKGROUND

Many types of devices communicate with each other to synchronize data, such as between servers and client devices, and between servers. For example, many different types of client devices, such as computing devices, mobile phones, and/or tablet devices, commonly sync with an email service to send and receive email messages, as well as update contacts and calendar events. Additionally, data servers of the email service commonly poll other email servers to synchronize and aggregate emails for download to the client devices.

There are typically two models or techniques that are utilized for data synchronization between devices, such as between servers and client devices, as well as between servers themselves and/or between client devices. One such technique is to establish a persistent connection between devices for approximate real-time data synchronization. This technique has the advantage of keeping data up-to-date between the devices in near real-time. However, a persistent connection comes with the disadvantage of over-utilizing resources, such as utilizing data bandwidth and consuming device power, which is not ideal for battery powered devices like mobile phones and tablet devices. Another technique for data synchronization between devices utilizes a static polling interval, where one device communicates to synchronize data with another device only every so often. This technique has the advantage of conserving system and/or device resources (e.g., data communication bandwidth, battery power, and processing). However, a static polling interval has the disadvantage of untimely updates and changes that are not often propagated, but rather at set intervals.

### SUMMARY

This Summary introduces features and concepts of dynamic intervals for synchronizing data, which is further described below in the Detailed Description and/or shown in the Figures. This Summary should not be considered to describe essential features of the claimed subject matter, nor used to determine or limit the scope of the claimed subject matter.

Dynamic intervals for synchronizing data is described. In embodiments, the data is periodically synchronized between computing devices, such as between server devices, client devices, and/or between client and server devices. A polling optimization service can assess heuristics that are associated with the data synchronizations between the computing devices, and determine optimal dynamic intervals to periodically synchronize the data based on the heuristics. The polling optimization service can then iterate to further assess the heuristics that are associated with subsequent data synchronizations and determine updates of the optimal dynamic intervals. The polling optimization service updates the heuristics based on the subsequent and ongoing data synchronizations, and iterates to update the optimal dynamic intervals based on the updated heuristics.

In implementations, the heuristics can include any type of context of the data that is periodically synchronized, the available processing resources of the computing devices to synchronize the data, and/or user interaction with applications that utilize the data, such as an email client application. For example, an email server distributes the data to a client device as email messages, contacts, and/or calendar event data, and the email client application at the client device polls the email server based on an optimal dynamic interval to synchronize the data.

In implementations, instances of the polling optimization service can be implemented by any one or more of the computing devices to control when the computing devices communicate to synchronize the data based on the optimal dynamic intervals. For example, a polling optimization service implemented by a server device can control the periodic synchronization of the data between the devices based on an optimal dynamic interval. Alternatively, the polling optimization service implemented by the server device can determine the optimal dynamic interval based on the heuristics, and communicate the optimal dynamic interval and/or the heuristics to a client device or other server device that then controls the data synchronizations between the devices. Alternatively, each of the computing devices can implement an instance of the polling optimization service, and collectively, the polling optimization services implemented by the respective devices assess the heuristics together and determine the optimal dynamic intervals and/or updates of the optimal dynamic intervals for the data synchronizations between the devices.

### BRIEF DESCRIPTION OF THE DRAWINGS

Embodiments of dynamic intervals for synchronizing data are described with reference to the following Figures. The same numbers may be used throughout to reference like features and components that are shown in the Figures:

FIG. 1 illustrates an example system in which embodiments of dynamic intervals for synchronizing data can be implemented.

FIG. 2 illustrates another example system in which embodiments of dynamic intervals for synchronizing data can be implemented.

FIG. 3 illustrates example method(s) of dynamic intervals for synchronizing data in accordance with one or more embodiments.

FIG. 4 illustrates an example system with an example device that can implement embodiments of dynamic intervals for synchronizing data.

### DETAILED DESCRIPTION

Embodiments of dynamic intervals for synchronizing data are described and may be implemented by any type of computing device, such as a server device, client device, or any other type of computing device that synchronizes data with another computing device. The data may be any type of data that is stored or maintained, and then transferred or periodically synchronized across multiple systems and/or any type of the computing devices. Instances of a polling optimization service can be implemented by any one or more of the computing devices in a system to assess heuristics that are associated with data synchronizations between the computing devices. The heuristics that are associated with data synchronizations can include any type of synchronization information and data information about the data that is periodically synchronized, as well as take into account the history of previous data synchronizations. The heuristics may also include synchronization information about the processing resources of the computing devices to synchronize the data, and/or user interaction with applications that utilize the data.

The instances of the polling optimization service that is implemented by any one or more of the computing devices can also determine optimal dynamic intervals for polling to periodically synchronize the data between computing devices based on the heuristics that are associated with the data synchronizations. The optimal dynamic intervals are learned, or smart, polling intervals that can be updated and adjusted based on the heuristics. The polling optimization service can then iterate to further assess updated heuristics that are associated with ongoing, subsequent data synchronizations and determine updates of the optimal dynamic intervals. This polling technique is not based on static intervals or a persistent connection that over-utilizes device resources as described above. The polling optimization service determines the dynamic polling intervals for data synchronizations that keep the data up-to-date between the computing devices without over-utilizing resources, such as processing and communication bandwidth, and without unnecessarily consuming device power. This polling technique can also provide a mechanism by which a server device can determine to off-load processing tasks and/or limit client device requests, such as to slow down or space out the client device requests so as not to overload server processing.

While features and concepts of dynamic intervals for synchronizing data can be implemented in any number of different devices, systems, networks, environments, and/or configurations, embodiments of dynamic intervals for synchronizing data are described in the context of the following example devices, systems, and methods.

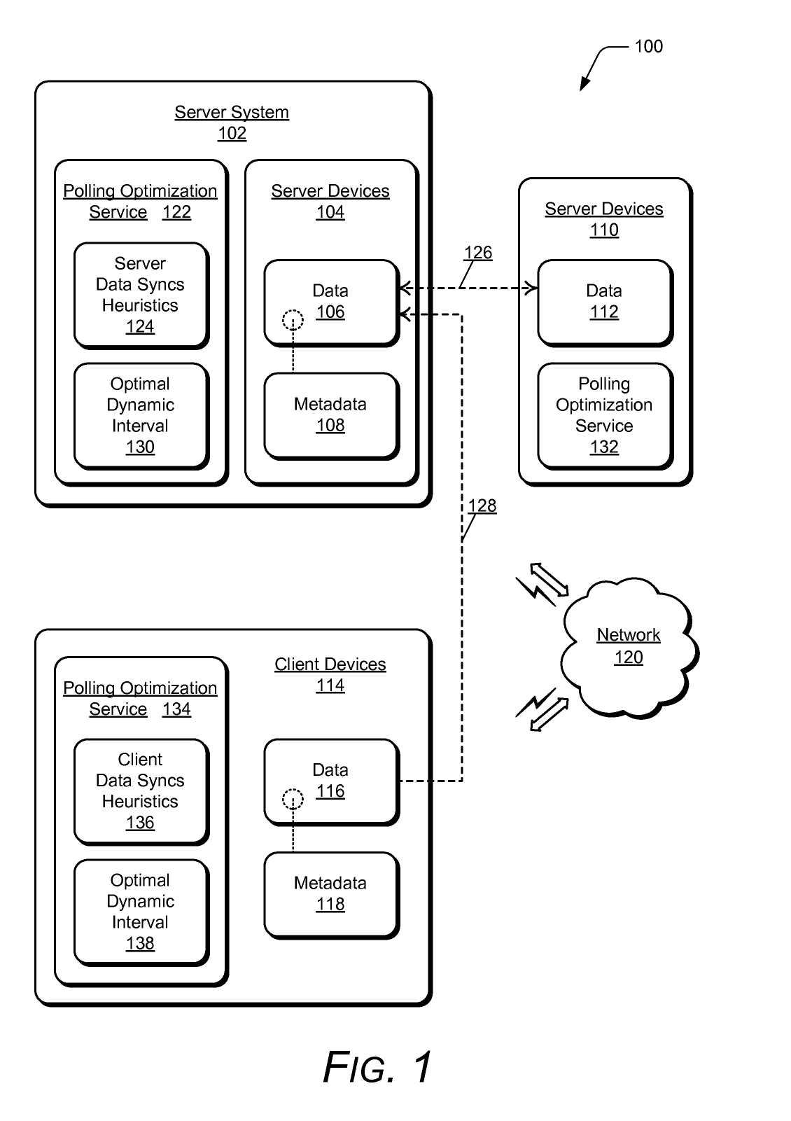

FIG. 1 illustrates an example system 100 in which embodiments of dynamic intervals for synchronizing data can be implemented. The system 100 includes a server system 102 with server devices 104 that may receive and/or distribute data 106 along with metadata 108 that is associated with the data. The data can include any type of data that is stored or maintained, and then periodically synchronized between computing devices, to include but not limited to, calendar events, contacts, data files, documents, database entries, and/or email messages. When the data 106 is synchronized between computing devices (e.g., server devices and/or client devices), the corresponding metadata 108 can be tracked, which may include identifiers or indications of the quantity of synchronized data, the type of data, over what time frame or duration the data is synchronized, a timestamp of the day and/or week, and the like. The server system 102 is representative of any Web-based data service (also referred to as cloud-based, or “in the cloud”), an enterprise or company-wide server system, or any other type of networked server system that receives, stores (e.g., maintains), and/or distributes data. The example system 100 may also include additional server devices 110 that store data 112, which is periodically synchronized with the data 106 that is maintained by one or more of the server devices 104 at the server system 102.

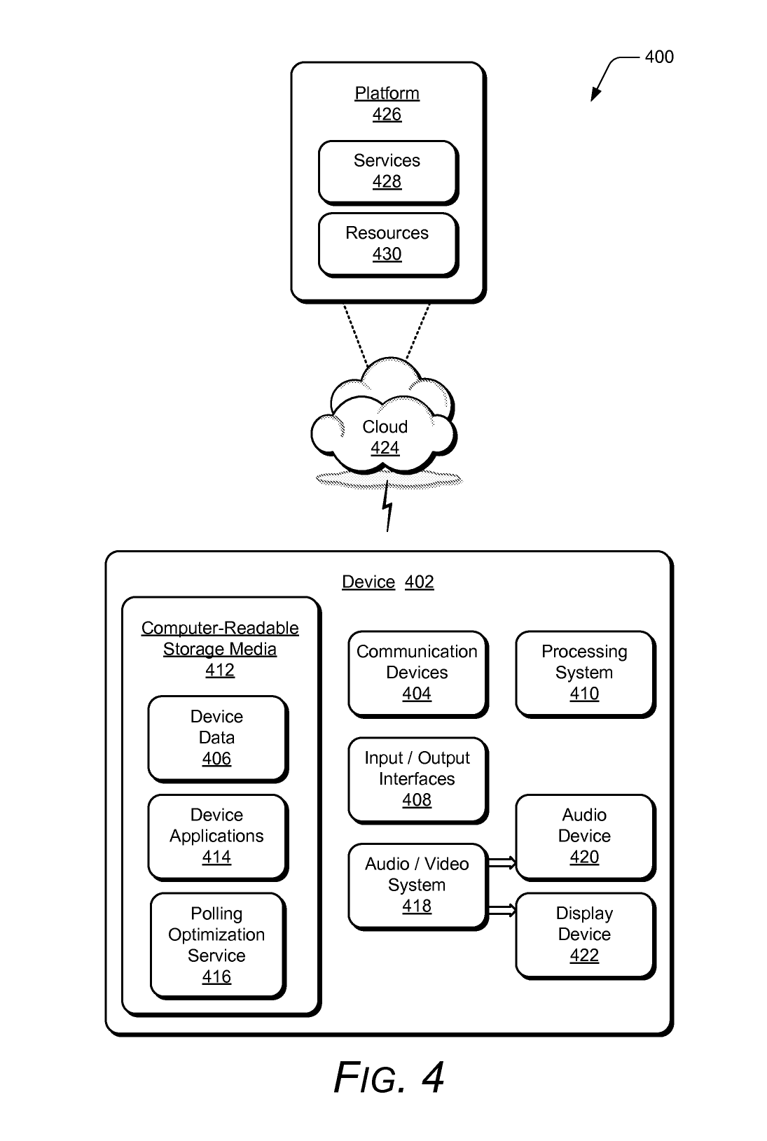

The example system 100 also includes example client devices 114. A client device may be any one or combination of a wired or wireless device, such as a mobile phone, tablet, computing, communication, entertainment, gaming, media playback, and/or other type of computing device. The client devices 114 may also store or maintain data 116, along with metadata 118, that is periodically synchronized with the data 106 maintained by one or more of the server devices 104 at the server system 102. Generally, any of the devices described herein, such as the server devices 104 of the server system 102, the server devices 110, and the client devices 114 are computing devices, which can be implemented with various components, such as a processing system and memory, as well as any number and combination of differing components as further described with reference to the example device shown in FIG. 4.

Any of the devices and servers described herein can communicate via a network 120, which can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

The server system 102 also includes a polling optimization service 122 that can be implemented as a software application (e.g., executable instructions) stored on computer-readable storage media, such as any suitable memory device or electronic data storage. The server system 102 can be implemented with computer-readable storage media as described with reference to the example device shown in FIG. 4 to maintain the polling optimization service 122 as a software application. Additionally, the polling optimization service can be executed with a processing system at the server system to implement embodiments of dynamic intervals for synchronizing data as described herein.

In embodiments, the polling optimization service 122 at the server system 102 is implemented to assess data synchronization heuristics 124 (generally referred to herein as heuristics) associated with data synchronizations at the server system. For example, a server device 104 may periodically synchronize the data 106 with the data 112 at one or more of the server devices 110, generally identified as the data synchronizations 126. Similarly, a server device 104 may periodically synchronize the data 106 with the data 116 at one or more of the client devices 114, generally identified as the data synchronizations 128.

In implementations, the heuristics 124 that are associated with the data synchronizations 126, 128 can include any synchronization information and data information about the data 106 that is periodically synchronized, such as the type of data, the quantity of the data that is synchronized, how often the data is available to update, temporal information (e.g., a timestamp and day, week, or other calendar information) associated with the data. The heuristics 124 may also take into account the history of previous data synchronizations, to include the types and quantity of data that was synchronized. For example, previous data synchronizations may have been initiated even though there was no data, or data items such as contacts or calendar events, to synchronize, which is an indication that the polling interval between data synchronizations can be increased. Alternatively, a large backlog of data to synchronize would be an indication that the polling interval between data synchronizations can be decreased so as to synchronize the data more often.

A context of the data may include any type of information related to the data synchronizations, to include the data information, the synchronization information, and previous synchronization information. The heuristics may also include synchronization information about the processing resources of the computing devices to synchronize the data, such as communication bandwidth between devices for the data synchronizations, processor resources of the devices, and/or power resources, such as for a battery-powered device.

In embodiments, the polling optimization service 122 at the server system 102 is also implemented to determine an optimal dynamic interval 130 to periodically synchronize the data 106 based on the heuristics 124. The optimal dynamic interval 130 on which to base the data synchronizations 126, 128 is a learned, or smart, dynamic polling interval that keeps the data up-to-date between the computing devices without over-utilizing resources, such as the processing and communication bandwidth resources, and without unnecessarily consuming device power (e.g., for battery-powered mobile devices).

The polling optimization service 122 at the server system 102 is implemented to iterate assessing the data synchronization heuristics 124 that are associated with the ongoing data synchronizations 126 to synchronize the data 106 with the data 112 at one or more of the server devices 110. The polling optimization service also iterates assessing the data synchronization heuristics 124 that are associated with the ongoing data synchronizations 128 to synchronize the data 106 with the data 116 at one or more of the client devices 114. The polling optimization service 122 can then determine updates of the optimal dynamic interval 130 based on assessing the updated data synchronization heuristics.

In implementations, the polling optimization service 122 at the server system 102 can control when a server device 104 communicates with an additional server device 110 to synchronize the data 106 with the data 112 based on the optimal dynamic interval 130 for server communication. Similarly, the polling optimization service 122 can control when a server device 104 communicates with a client device 114 to synchronize the data 106 with the data 116 based on an optimal dynamic interval 130 for the client and server communication. The optimal dynamic interval 130 can be determined based on the data synchronization heuristics 124 as a different interval for each of the server devices 110 and/or for each of the client devices 114 to synchronize data with the server system 102.

In alternate implementations, the polling optimization service 122 can initiate communication of the optimal dynamic interval 130 to a server device 110, and the computing device (e.g., the server device 110) then controls the data synchronizations 126 with the server devices 104. Similarly, the polling optimization service 122 can initiate communication of the optimal dynamic interval 130 to a client device 114, and the computing device (e.g., the client device 114) then controls the data synchronizations 128 with the server devices 104.

In alternate implementations, the polling optimization service 122 that is implemented at the server system 102 can communicate with another polling optimization service implemented at one of the other computing devices to determine an optimal dynamic interval for the data synchronizations between the computing devices. For example, a server device 110 can include a polling optimization service 132, which can be implemented as described with reference to the polling optimization service 122 at the server system 102. Similarly, a client device 114 can include a polling optimization service 134, which can be implemented as described with reference to the polling optimization service 122 at the server system 102. For example, the polling optimization service 134 is implemented at a client device 114 to assess data synchronization heuristics 136 (generally referred to herein as heuristics) associated with data synchronizations at the client device, and determine an optimal dynamic interval 138 to periodically synchronize the data 116 based on the heuristics 136.

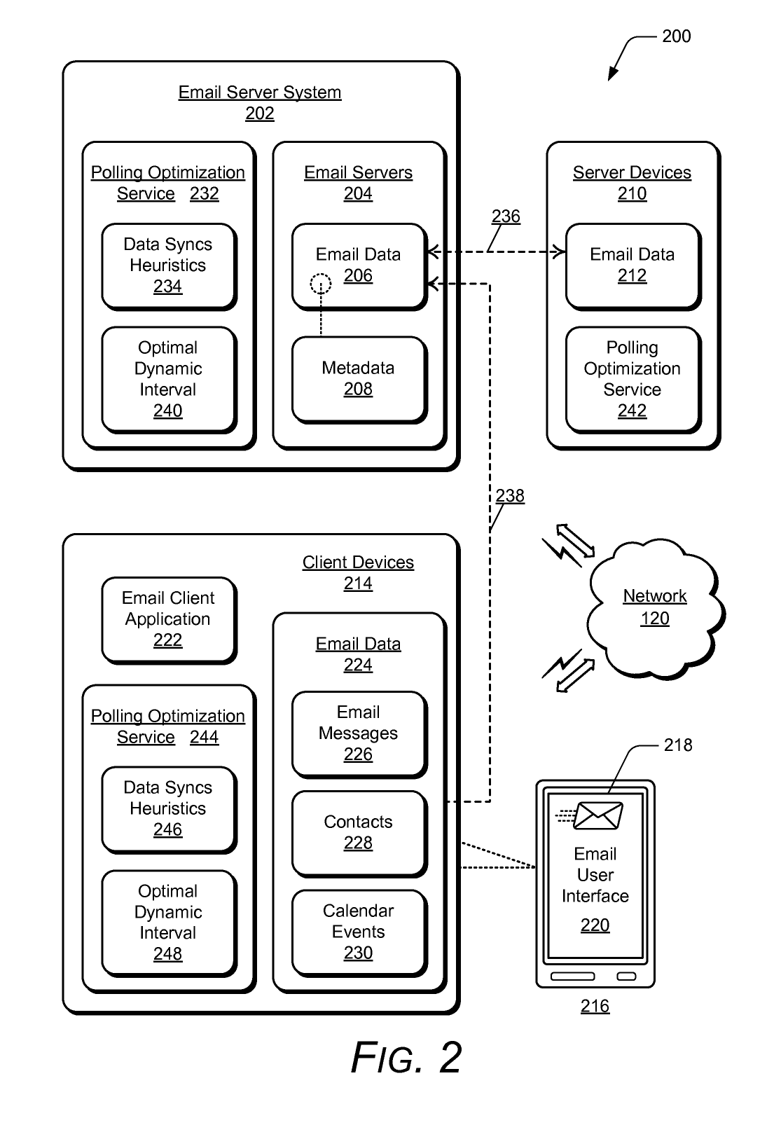

FIG. 2 illustrates an example system 200 in which embodiments of dynamic intervals for synchronizing data can be implemented. The system 200 includes an email server system 202 with email servers 204 that may receive and/or distribute email data 206, such as email messages that are received for storage, routing, and distribution to designated email recipients. When the email data 206 is synchronized between computing devices (e.g., server devices and/or client devices), corresponding metadata 208 can be tracked, which may include identifiers or indications of the quantity of synchronized data, the type of data, over what time frame or duration the data is synchronized, a timestamp of the day and/or week, and the like. The email server system 202 is representative of any Web-based email hosting service (also referred to as cloud-based, or “in the cloud”), an enterprise or company-wide email system, or any other type of networked email server system that receives, stores (e.g., maintains), and/or distributes email data. The example system 200 may also include additional server devices 210 that have email data 212, which is periodically synchronized, such as to aggregate email messages with the email data 206 that is maintained by one or more of the email servers 204 at the email server system 202.

The example system 200 also includes example client devices 214. A client device may be any one or combination of a wired or wireless device, such as a mobile phone, tablet, computing, communication, entertainment, gaming, media playback, and/or other type of computing device that may be utilized to read and send emails, maintain a calendar, and store user contacts. For example, a mobile phone 216 includes an integrated display device 218 on which an email application user interface 220 can be displayed to facilitate interaction with an email client application 222. A client device 214 may also store or maintain email data 224, such as email messages 226, contacts 228, and calendar events 230.

The email data 224 can be periodically synchronized with the email data 206 that is maintained by one or more of the email servers 204 at the email server system 202. Generally, any of the devices described herein, such as the email servers 204 of the email server system 202, the server devices 210, and the client devices 214 are computing devices, which can be implemented with various components, such as a processing system and memory, as well as any number and combination of differing components as further described with reference to the example device shown in FIG. 4. Additionally, any of the devices and servers described herein can communicate via the network 120, as described with reference to FIG. 1.

The email server system 202 also includes a polling optimization service 232 that can be implemented as a software application (e.g., executable instructions) stored on computer-readable storage media, such as any suitable memory device or electronic data storage. The email server system 202 can be implemented with computer-readable storage media as described with reference to the example device shown in FIG. 4 to maintain the polling optimization service 232 as a software application. Additionally, the polling optimization service can be executed with a processing system at the email server system to implement embodiments of dynamic intervals for synchronizing data as described herein.

In embodiments, the polling optimization service 232 at the email server system 202 is implemented to assess data synchronization heuristics 234 (generally referred to herein as heuristics) associated with data synchronizations at the email server system. For example, an email server 204 may periodically synchronize to update the email data 206 from the email data 212 at one or more of the server devices 210, generally identified as the data synchronizations 236. The email servers 204 may also periodically synchronize the email data 206 with the email data 224 at one or more of the client devices 214, generally identified as the data synchronizations 238.

In an example, a user may set up a Post Office Protocol (POP) to aggregate emails (e.g., the email data 212) from the server devices 210 to the email server system 202 (e.g., a Web-based email hosting service), such as if the user is switching email accounts or setting up a new email account with the email hosting service. The optimal dynamic interval 240 to poll for data synchronizations 236 may initially be set for every thirty minutes. However, the polling optimization service 232 determines and dynamically updates the optimal dynamic interval to poll for data synchronizations every five minutes while the user receives quite a lot of email messages from the previous email provider, and the user frequently interacts from a client device to access email. When the switch to the new email hosting service is completed, the previous email provider receives far fewer emails for the user and the polling optimization service 232 can again adjust the optimal dynamic interval to poll for data synchronizations only every so often, such as once every twelve hours, or longer.

In implementations, the heuristics 234 that are associated with the data synchronizations 236, 238 can include any synchronization information and data information about the email data 206 that is periodically synchronized, such as the type of data (e.g., email messages, contacts, or calendar events), the quantity of the data that is synchronized, how often the email data is available to update, and/or temporal information (e.g., a timestamp and day, week, or other calendar information) associated with the email data. The heuristics 234 may also take into account the history of previous data synchronizations, to include the types and quantity of data that was synchronized. For example, previous data synchronizations may have been initiated even though there was no data, or data items such as emails, to synchronize, which is an indication that the polling interval between data synchronizations can be increased. Alternatively, a large backlog of data to synchronize would be an indication that the polling interval between data synchronizations can be decreased so as to synchronize the data more often.

A context of the data may include any type of information related to the data synchronizations, to include the data information, the synchronization information, and previous synchronization information. The heuristics may also include synchronization information about the processing resources of the computing devices to synchronize the email data, such as communication bandwidth between devices for the data synchronizations, processor resources of the devices, and/or power resources, such as for a battery-powered device.

In embodiments, the polling optimization service 232 at the email server system 202 is also implemented to determine an optimal dynamic interval 240 to periodically synchronize the email data 206 based on the heuristics 234. The optimal dynamic interval 240 on which to base the data synchronizations 236, 238 is a learned, or smart, polling interval that keeps the email data up-to-date between the computing devices without over-utilizing resources, such as the processing and communication bandwidth resources, and without unnecessarily consuming device power (e.g., for battery-powered mobile devices).

The polling optimization service 232 at the email server system 202 is implemented to iterate assessing the data synchronization heuristics 234 that are associated with the ongoing data synchronizations 236 to synchronize the email data 206 with the email data 212 at one or more of the email servers 204. The polling optimization service also iterates assessing the data synchronization heuristics 234 that are associated with the ongoing data synchronizations 238 to synchronize the email data 206 with the email data 224 at one or more of the client devices 214. The polling optimization service 232 can then determine updates of the optimal dynamic interval 240 based on assessing the updated data synchronization heuristics.

In implementations, the polling optimization service 232 at the email server system 202 can control when an email server 204 communicates with an additional server device 210 to synchronize the email data 206 with the email data 212 based on the optimal dynamic interval 240 for server communication. Similarly, the polling optimization service 232 can control when an email server 204 communicates with a client device 214 to synchronize the email data 206 with the client device email data 224 based on an optimal dynamic interval 240 for the client and server communication. The optimal dynamic interval 240 can be determined based on the data synchronization heuristics 234 as a different interval for each of the server devices 210 and/or for each of the client devices 214 to synchronize the email data with the email server system 202.

In alternate implementations, the polling optimization service 232 can initiate communication of the optimal dynamic interval 240 to a server device 210, and the computing device (e.g., the server device 210) then controls the data synchronizations 236 with the email servers 204. Similarly, the polling optimization service 232 can initiate communication of the optimal dynamic interval 240 to a client device 214, and the computing device (e.g., the client device 214) then controls the data synchronizations 238 with the email servers 204.

In alternate implementations, the polling optimization service 232 that is implemented at the email server system 202 can communicate with another polling optimization service implemented at one of the other computing devices to determine an optimal dynamic interval for the data synchronizations between the computing devices. For example, a server device 210 can include a polling optimization service 242, which can be implemented as described with reference to the polling optimization service 232 at the email server system 202.

Similarly, a client device 214 can include a polling optimization service 244, which can be implemented as described with reference to the polling optimization service 232 at the email server system 202. For example, the polling optimization service 244 is implemented at a client device 214 to assess data synchronization heuristics 246 (generally referred to herein as heuristics) associated with data synchronizations at the client device, and determine an optimal dynamic interval 248 to periodically synchronize the email data 224 based on the heuristics 246.

The heuristics 246 that are assessed at a client device 214 and associated with the data synchronizations 238 can include any context of the email data 224 that is periodically synchronized from the email server system 202, such as the type of data (e.g., the email messages 226, the contacts 228, and/or the calendar events 230), how often the email data is available to update, and/or temporal information (e.g., a timestamp and day, week, or other calendar information) associated with the email data. The heuristics may also include information about the available processing resources of a client device 214 to synchronize the email data and/or include user interaction with an application that utilizes the data. For example, the heuristics 246 can include information about user log-in and interaction with the email client application 222, which utilizes the email data 224.

A user at a client device 214 may interact with the email client application 222 via the email user interface 220, such as on the mobile phone 216. The heuristics 246 at the client device includes the user log-in information, such as when the user typically interacts with the email client application and for how long. For example, a user may be synching the email data 224 down to their mobile phone 216 and the user receives a lot of email, so the optimal dynamic interval to poll for data synchronization is every ten minutes, and may even decrease down to a persistent or near-persistent connection that will quickly drain device battery power. However, the user may only log-in and interact with the email client application 222 every few hours to access and view the email messages. Based on over-utilizing the device resources (e.g., battery power and processing to synchronize the email data), and the lack of user interaction with the email client application 222, the optimal dynamic interval 248 can be increased, such as to poll for data synchronization every hour or even longer.

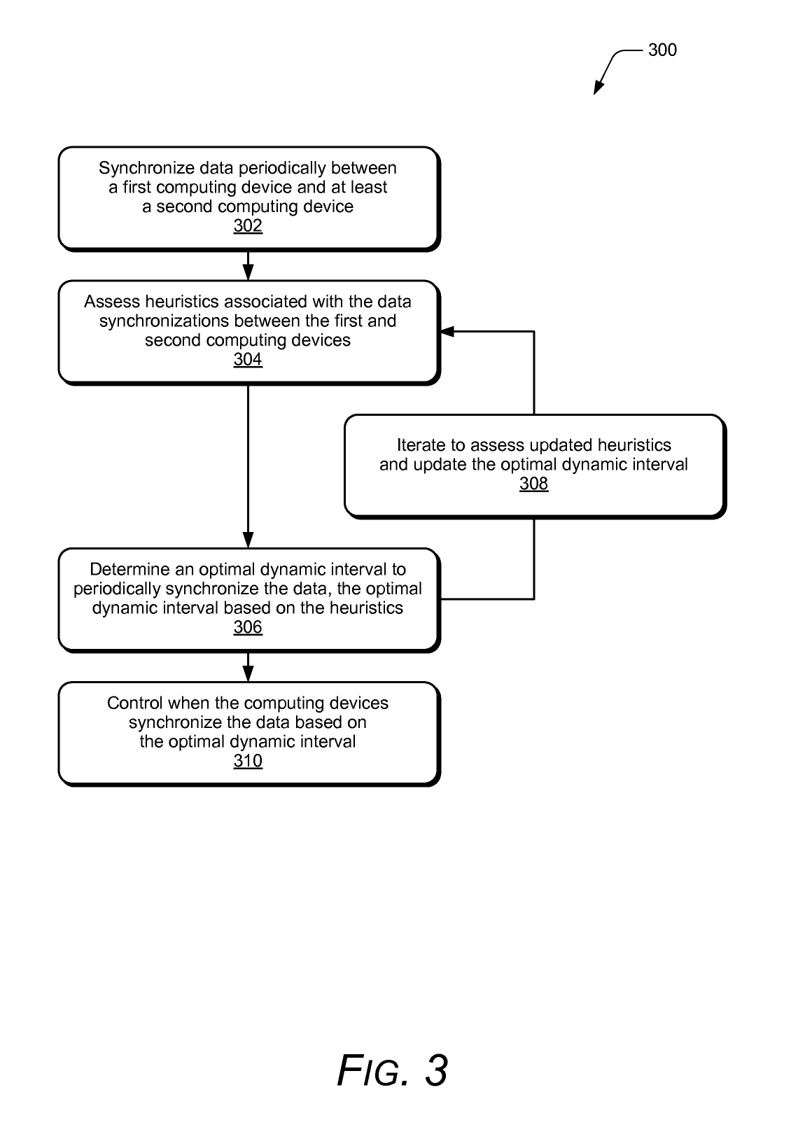

Example method 300 is described with reference to FIG. 3 in accordance with one or more embodiments of dynamic intervals for synchronizing data. Generally, any of the services, components, modules, methods, and operations described herein can be implemented using software, firmware, hardware (e.g., fixed logic circuitry), manual processing, or any combination thereof. The example methods may be described in the general context of executable instructions stored on computer-readable storage media that is local and/or remote to a computer processing system, and implementations can include software applications, programs, functions, and the like.

FIG. 3 illustrates example method(s) 300 of dynamic intervals for synchronizing data, and is generally described with reference to a polling optimization service implemented at a computing device. The order in which the method is described is not intended to be construed as a limitation, and any number or combination of the method operations can be performed in any order to implement a method, or an alternate method.

At 302, data is periodically synchronized between a first computing device and at least a second computing device. For example, the data 106 at the server system 102 (FIG. 1) is periodically synchronized between computing devices (e.g., the server devices 104, 110 and/or the client devices 114). The server devices 110 maintain data 112, the client devices 114 maintain data 116, and the data is periodically synchronized with the data 106 that is maintained by one or more of the server devices 104 at the server system 102. Similarly, the email data 206 at the email server system 202 (FIG. 2) is periodically synchronized between computing devices (e.g., the email servers 204, server devices 210, and/or the client devices 214). The server devices 210 maintain email data 212, the client devices 214 maintain email data 224, and the email data is periodically synchronized with the email data 206 that is maintained by one or more of the email servers 204 at the email server system 202.

At 304, heuristics associated with the data synchronizations between the first and second computing devices are assessed. For example, the polling optimization service 122 at the server system 102 assess the data synchronization heuristics 124 (generally referred to herein as heuristics) associated with the data synchronizations at the server system, such as the data synchronizations 126 between server devices and the data synchronizations 128 between client and server devices. Similarly, the polling optimization service 134 implemented by a client device 114 assess the data synchronization heuristics 136 that are associated with the data synchronizations 128 between the client device and the server devices of the server system.

Additionally, the polling optimization service 232 at the email server system 202 assess the data synchronization heuristics 234 associated with the data synchronizations at the email server system, such as the data synchronizations 236 between email servers and the data synchronizations 238 between client and server devices. Similarly, the polling optimization service 244 implemented by a client device 214 assess the data synchronization heuristics 246 that are associated with the data synchronizations 238 between the client device and the email servers of the email server system.

At 306, an optimal dynamic interval is determined to periodically synchronize the data, the optimal dynamic interval based on the heuristics. For example, the polling optimization service 122 at the server system 102 determines the optimal dynamic interval 130 based on the heuristics 124, and the optimal dynamic interval is the polling interval to initiate periodically synchronizing the data 106, such as with the server devices 110 via the data synchronizations 126 and/or with the client devices 114 via the data synchronizations 128. Similarly, the polling optimization service 134 at a client device 114 determines the optimal dynamic interval 138 for the data synchronizations 128 between the client device and the server devices.

Additionally, the polling optimization service 232 at the email server system 202 determines the optimal dynamic interval 240 based on the heuristics 234 to initiate periodically synchronizing the email data 206, such as with the server devices 210 via the data synchronizations 236 and/or with the client devices 214 via the data synchronizations 238. Similarly, the polling optimization service 244 at a client device 214 determines the optimal dynamic interval 248 for the data synchronizations 238 between the client device and the email servers.

At 308, the method continues to iterate assessing updated heuristics that are associated with the data synchronizations, and to determine updates of the optimal dynamic interval. For example, the polling optimization service 122 at the server system 102 iterates assessing the data synchronization heuristics 124 that are associated with the data synchronizations (e.g., ongoing, subsequent data synchronizations), and determines updates of the optimal dynamic interval 130 based on assessing the updated data synchronization heuristics at the server system. Similarly, the polling optimization service 134 at a client device 114 iterates assessing the data synchronization heuristics 136 that are associated with the ongoing, subsequent data synchronizations 128, and the polling optimization service determines updates of the optimal dynamic interval 138 based on assessing the updated data synchronization heuristics at the client device.

Additionally, the polling optimization service 232 at the email server system 202 iterates assessing the data synchronization heuristics 234 that are associated with the ongoing, subsequent data synchronizations, and determines updates of the optimal dynamic interval 240 based on assessing the updated data synchronization heuristics at the email server system. Similarly, the polling optimization service 244 at a client device 214 iterates assessing the data synchronization heuristics 246 that are associated with the ongoing, subsequent data synchronizations 238, and the polling optimization service determines updates of the optimal dynamic interval 248 based on assessing the updated data synchronization heuristics at the client device.

At 310, the data synchronizations between the computing devices are controlled based on the optimal dynamic interval. For example, the polling optimization service 122 at the server system 102 controls when a server device 104 communicates with an additional server device 110 to synchronize the data 106 with the data 112 based on the optimal dynamic interval 130 for server communication. Similarly, the polling optimization service 122 controls when a server device 104 communicates with a client device 114 to synchronize the data 106 with the data 116 based on the optimal dynamic interval 130 for the client and server communication. Similarly, the polling optimization service 134 implemented at a client device 114 can control when the client device communicates with a server device 104 to synchronize the data 116 with the data 106 based on the optimal dynamic interval 138 for the client and server communication. The optimal dynamic intervals 130 and 138 can be determined based on the respective data synchronization heuristics 124 and 136 as different intervals for each of the server devices 104, 110 and/or for each of the client devices 114 to synchronize the data.

Additionally, the polling optimization service 232 at the email server system 202 controls when an email server 204 communicates with an additional server device 210 to synchronize the email data 206 with the email data 212 based on the optimal dynamic interval 240 for server communication. Similarly, the polling optimization service 232 controls when an email server 204 communicates with a client device 214 to synchronize the email data 206 with the email data 224 based on the optimal dynamic interval 240 for the client and server communication. Similarly, the polling optimization service 244 implemented at a client device 214 can control when the client device communicates with an email server 204 to synchronize the email data 224 with the email data 206 based on the optimal dynamic interval 248 for the client and server communication.

FIG. 4 illustrates an example system 400 that includes an example device 402, which can implement embodiments of dynamic intervals for synchronizing data. The example device 402 can be implemented as any of the devices and/or servers described with reference to the previous FIGS. 1-3, such as any type of client device, mobile phone, tablet, computing, communication, entertainment, gaming, media playback, and/or other type of device. For example, the server system 102 and email server system 202, the various server devices, and/or the client devices 114, 214 shown in respective FIGS. 1 and 2 may be implemented as the example device 402.

The device 402 includes communication devices 404 that enable wired and/or wireless communication of device data 406, such as email messages or any other type of data that is periodically synchronized between computing devices. Additionally, the device data can include any type of audio, video, and/or image data. The communication devices 404 can also include transceivers for cellular phone communication and for network data communication.

The device 402 also includes input/output (I/O) interfaces 408, such as data network interfaces that provide connection and/or communication links between the device, data networks, and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of audio, video, and/or image data received from any content and/or data source.

The device 402 includes a processing system 410 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 402 may further include any type of a system bus or other data and command transfer system that couples the various components within the device. A system bus can include any one or combination of different bus structures and architectures, as well as control and data lines.

The device 402 also includes computer-readable storage media 412, such as data storage devices that can be accessed by a computing device, and that provide persistent storage of data and executable instructions (e.g., software applications, programs, functions, and the like). Examples of computer-readable storage media include volatile memory and non-volatile memory, fixed and removable media devices, and any suitable memory device or electronic data storage that maintains data for computing device access. The computer-readable storage media can include various implementations of random access memory (RAM), read-only memory (ROM), flash memory, and other types of storage media in various memory device configurations.

The computer-readable storage media 412 provides storage of the device data 406 and various device applications 414, such as an operating system that is maintained as a software application with the computer-readable storage media and executed by the processing system 410. In this example, the device applications also include a polling optimization service 416 that implements embodiments of dynamic intervals for synchronizing data as described herein. Examples of the polling optimization service 416 are implemented in the various computing devices as described with reference to FIGS. 1-3.

The device 402 also includes an audio and/or video system 418 that generates audio data for an audio device 420 and/or generates display data for a display device 422. The audio device and/or the display device include any devices that process, display, and/or otherwise render audio, video, display, and/or image data. In implementations, the audio device and/or the display device are integrated components of the example device 402. Alternatively, the audio device and/or the display device are external, peripheral components to the example device.

In embodiments, at least part of the techniques described for dynamic intervals for synchronizing data may be implemented in a distributed system, such as over a “cloud” 424 in a platform 426. The cloud 424 includes and/or is representative of the platform 426 for services 428 and/or resources 430. For example, the services 428 may include any of the polling optimization services, the server system 102 and/or the email server system 202, and the various server devices described with reference to FIGS. 1 and 2. For example, an independent cloud-based polling optimization service can assess the heuristics from any one or more of the computing devices in a system to determine the optimal dynamic intervals for data synchronization between the respective computing devices. Additionally, the resources 430 may also include the polling optimization services, as well as any types of data described with reference to FIGS. 1-3.

The platform 426 abstracts underlying functionality of hardware, such as server devices (e.g., included in the services 428) and/or software resources (e.g., included as the resources 430), and connects the example device 402 with other devices, servers, etc. The resources 430 may also include applications and/or data that can be utilized while computer processing is executed on servers that are remote from the example device 402. Additionally, the services 428 and/or the resources 430 may facilitate subscriber network services, such as over the Internet, a cellular network, or Wi-Fi network. The platform 426 may also serve to abstract and scale resources to service a demand for the resources 430 that are implemented via the platform, such as in an interconnected device embodiment with functionality distributed throughout the system 400. For example, the functionality may be implemented in part at the example device 402 as well as via the platform 426 that abstracts the functionality of the cloud 424.

Although embodiments of dynamic intervals for synchronizing data have been described in language specific to features and/or methods, the appended claims are not necessarily limited to the specific features or methods described. Rather, the specific features and methods are disclosed as example implementations of dynamic intervals for synchronizing data.

1. A computing device, comprising:
a memory device configured to maintain data that is periodically synchronized with at least one additional computing device;
a processing system to implement a polling optimization service that is configured to:
assess heuristics associated with the data synchronizations, the heuristics including at least data information and synchronization information;
determine an optimal dynamic interval to periodically synchronize the data based on the heuristics; and
iterate to said assess the heuristics associated with subsequent data synchronizations and to said determine updates of the optimal dynamic interval.

2. A computing device as recited in claim 1, wherein:
the data information of the heuristics includes at least a type of the data and a quantity of the data that is synchronized; and
the synchronization information of the heuristics includes at least previous information associated with the data synchronizations.

3. A computing device as recited in claim 1, wherein:
the computing device is a server device that communicates with the additional computing device configured as one of a client device or additional server device; or
the computing device is a client device that communicates with the additional computing device configured as one of a server device or an additional client device.

4. A computing device as recited in claim 1, wherein:
the additional computing device is an email server configured to distribute the data as at least one of email messages, contacts, and calendar event data; and
the processing system further implements an email client that is configured to poll the email server based on the optimal dynamic interval to synchronize the data.

5. A computing device as recited in claim 1, wherein the polling optimization service is configured to control when the computing device and the additional computing device communicate to synchronize the data based on the optimal dynamic interval.

6. A computing device as recited in claim 1, wherein the polling optimization service is configured to initiate communication of the optimal dynamic interval to the additional computing device that controls when to synchronize the data.

7. A computing device as recited in claim 1, wherein:
the polling optimization service is configured to communicate with an additional polling optimization service implemented by the additional computing device; and
the polling optimization service and the additional polling optimization service together determine when to synchronize the data based on the optimal dynamic interval.

8. A computing device as recited in claim 1, wherein the polling optimization service is configured to update the heuristics based on the subsequent data synchronizations with the additional computing device, and said iterate to determine the update of the optimal dynamic interval based on the updated heuristics.

9. A computing device as recited in claim 1, wherein the heuristics include one or more of:
a context of the data that is periodically synchronized;
processing resources of the computing device to synchronize the data; and
user interaction with an application that utilizes the data.

10. A method, comprising:
synchronizing data periodically between a first computing device and at least a second computing device;
assessing heuristics associated with the data synchronizations between the first and second computing devices;
determining an optimal dynamic interval to periodically synchronize the data, the optimal dynamic interval based on the heuristics; and
iterating said assessing the heuristics associated with subsequent data synchronizations and said determining updates of the optimal dynamic interval.

11. A method as recited in claim 10, wherein the first computing device is a server device communicating to synchronize the data with the second computing device configured as one of a client device or additional server device.

12. A method as recited in claim 10, wherein the first computing device is a client device communicating to synchronize the data with the second computing device configured as one of a server device or an additional client device.

13. A method as recited in claim 10, further comprising controlling, from the first computing device, when the first and second computing devices synchronize the data based on the optimal dynamic interval.

14. A method as recited in claim 10, wherein:
said assessing the heuristics includes assessing first heuristics associated with the data synchronizations at the first computing device and assessing second heuristics associated with the data synchronizations at the second computing device; and
said determining the optimal dynamic interval is based on both the first heuristics at the first computing device and the second heuristics at the second computing device.

15. A method as recited in claim 10, further comprising updating the heuristics based on the subsequent data synchronizations between the first and second computing devices, and said iterating to determine the update of the optimal dynamic interval based on the updated heuristics.

16. A method as recited in claim 10, wherein the heuristics include one or more of:
a context of the data that is periodically synchronized between the first and second computing devices, the context of the data including at least data information and synchronization information associated with the data synchronizations;
processing resources of the first and second computing devices to synchronize the data; and
user interaction with an application that utilizes the data.

17. A system, comprising:
a client device that implements an email client configured to request updates to email data from one or more server devices;
a polling optimization service configured to:
assess heuristics associated with periodic data synchronizations of the email data; and
determine an optimal dynamic interval to periodically synchronize the email data based on the heuristics.

18. A system as recited in claim 17, wherein:
the heuristics are associated with the periodic data synchronizations between the client device and a server device;
the client device implements a first instance of the polling optimization service configured to assess the heuristics;
the server device implements a second instance of the polling optimization service configured to assess the heuristics; and
the first and second instances of the polling optimization service are configured to determine the optimal dynamic interval in conjunction with each other.

19. A system as recited in claim 17, wherein:
the email data includes email messages, contacts, and calendar event data; and
the heuristics are associated with one of:
the periodic data synchronizations of the email data between the one or more server devices; or
the periodic data synchronizations of the email data between the client device and the one or more server devices.

20. A system as recited in claim 17, wherein the polling optimization service is configured to iterate to said assess the heuristics associated with the periodic data synchronizations of the email data and to said determine updates of the optimal dynamic interval.
